(19) United States
(12) Patent Application Publication
(10) Pub. No.: US 2015/0277693 A1
(43) Pub. Date: Oct. 1, 2015

(54) PRODUCTION PLAN PREPARATION SUPPORT METHOD AND PRODUCTION PLAN PREPARATION SUPPORT APPARATUS

(71) Applicant: FUJITSU LIMITED, Kawasaki-shi (JP)

(72) Inventors: Jun FUKAO, Ichinomiya (JP); Tatsuya ISHIHARA, Yokohama (JP); Hirotaka ITO, Kasugai (JP)

(73) Assignee: FUJITSU LIMITED, Kawasaki-shi (JP)

(21) Appl. No.: 14/615,060

(22) Filed: Feb. 5, 2015

(30) Foreign Application Priority Data
Mar. 28, 2014 (JP) 2014-070539

(51) Int. Cl. G06F 3/0486; G06F 3/0484; G05B 19/04

(52) U.S. Cl. CPC G06F 3/0486; G05B 19/0405; G06F 3/04847; G06F 3/04842; G05B 2219/23258

(57) ABSTRACT

A non-transitory computer-readable recording medium stores a production plan preparation support program. The production plan preparation support program causes a computer to execute a process including: displaying a Gantt chart including a plurality of task objects in a first window area and a second window area; and displaying, when detecting an operation of selecting a task object on the Gantt chart displayed in the first window area and disposing the task object on the Gantt chart displayed in the second window area, a result of moving the task object on the Gantt chart displayed in the first window area and the second window area, in a position where the task object is disposed on the Gantt chart displayed in the second window area.

### CROSS-REFERENCE TO RELATED APPLICATION

This application is based upon and claims the benefit of priority of the prior Japanese Patent Application No. 2014-070539, filed on Mar. 28, 2014, the entire contents of which are incorporated herein by reference.

### FIELD

The embodiments discussed herein are directed to a production plan preparation support program, a production plan preparation support method, and a production plan preparation support apparatus.

### BACKGROUND

Conventionally, there are software for managing a production plan for products or the like by displaying a Gantt chart and editing each task object on the Gantt chart. In such software, for example, a main image displayed in a single window is divided to display a production process of the ordered product and a table of the process assigned to mechanical facilities included in the factory in a Gantt chart form. The production process of the product is dragged and dropped on the Gantt chart for the mechanical facility, to assign each production step to the mechanical facility.

Patent Document 1: Japanese Laid-open Patent Publication No. 2008-299762

The above technique may complicate edit of the production plan. For example, in the case where the scale of the production is large, there are cases where the display area is insufficient for task with a single window and edit of the production plan becomes complicated. In addition, in the above technique, the production process is assigned to the machine facilities with reference to the production process of the product. However, for example, when the production process is edited between a plurality of mechanical facilities, a range of display is moved to edit the production process between the mechanical facilities, whereby edit of the production plan becomes complicated.

### SUMMARY

According to an aspect of an embodiment, a non-transitory computer-readable recording medium stores a production plan preparation support program. The production plan preparation support program causes a computer to execute a process including: displaying a Gantt chart including a plurality of task objects in a first window area and a second window area; and displaying, when detecting an operation of selecting a task object on the Gantt chart displayed in the first window area and disposing the task object on the Gantt chart displayed in the second window area, a result of moving the task object on the Gantt chart displayed in the first window area and the second window area, in a position where the task object is disposed on the Gantt chart displayed in the second window area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a schematic configuration of the entire system;

FIG. 2 is a diagram illustrating an example of a functional configuration of a production plan preparation support apparatus;

FIG. 3 is a diagram illustrating an example of a data configuration of task information;

FIG. 4 is a diagram illustrating an example of a data configuration of production facility information;

FIG. 5 is a diagram illustrating an example of a data configuration of switching task information;

FIG. 6A is a diagram illustrating an example of a production plan image in which a production plan is displayed;

FIG. 6B is a diagram illustrating the example of the production plan image in which the production plan is displayed;

FIG. 6C is a diagram illustrating the example of the production plan image in which the production plan is displayed;

FIG. 7 is a schematic diagram of an image area of the production plan image;

FIG. 8 is a diagram illustrating patterns of the displayed part;

FIG. 9A is a diagram illustrating an example of arrangement of window areas;

FIG. 9B is a diagram illustrating an example of arrangement of window areas;

FIG. 9C is a diagram illustrating an example of arrangement of window areas;

FIG. 10A is a diagram illustrating an example of a production plan image in which a production plan is displayed;

FIG. 10B is a diagram illustrating the example of the production plan image in which the production plan is displayed;

FIG. 10C is a diagram illustrating the example of the production plan image in which the production plan is displayed;

FIG. 11 is a flowchart illustrating an example of procedures of a movement destination distinction display process;

FIG. 12 is a flowchart illustrating an example of procedures of a task period display process;

FIG. 13 is a flowchart illustrating an example of procedures of a movement process; and

FIG. 14 is a diagram illustrating a computer that executes a production plan preparation support program.

### DESCRIPTION OF EMBODIMENTS

Preferred embodiments of the present invention will be explained with reference to accompanying drawings. These embodiments do not restrict the invention. The embodiments may be properly combined as far as not making the details of the processes conflict with each other.

### [a] First Embodiment

### System Configuration

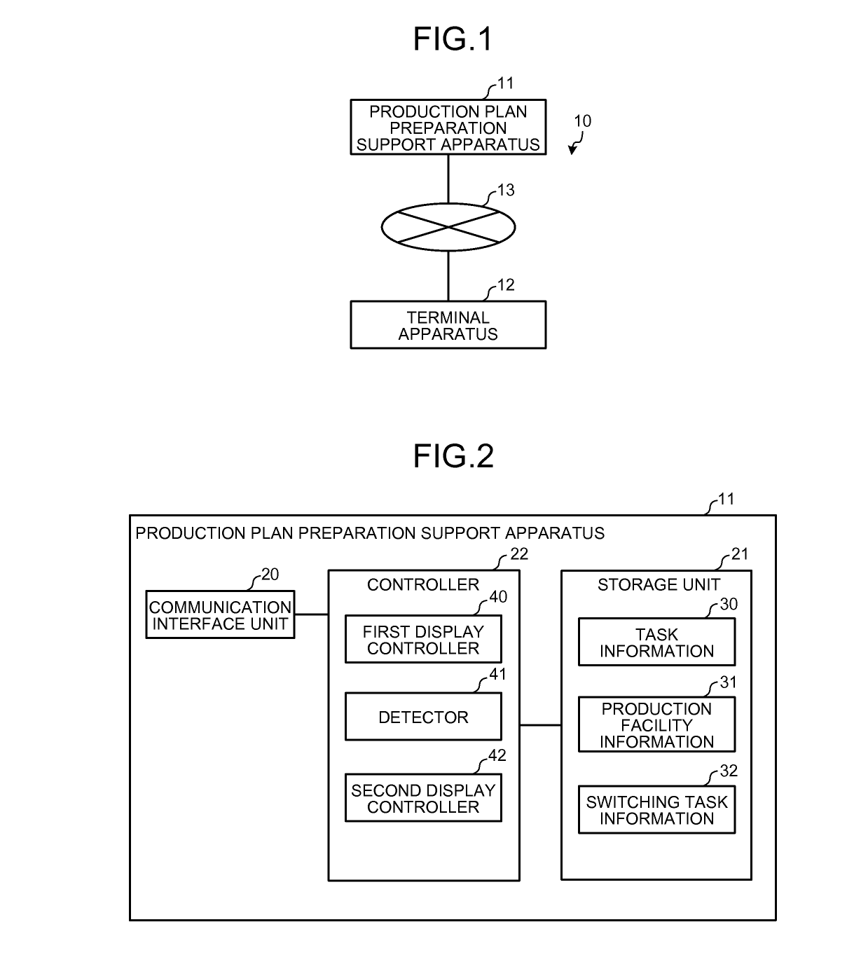

A system 10 according to a first embodiment will be explained hereinafter. FIG. 1 is a diagram illustrating an example of a schematic configuration of the entire system. As illustrated in FIG. 1, the system 10 is a system that supports preparation of a production plan for products or the like. The system 10 includes a production plan preparation support apparatus 11 and a terminal apparatus 12. The production plan preparation support apparatus 11 and the terminal apparatus 12 are capable of exchanging various pieces of information. For example, the production plan preparation support apparatus 11 and the terminal apparatus 12 are connected with each other via a network 13 to be enabled to perform communication and exchange various pieces of information. A communication network of a desired type may be adopted as a form of the network 13, such as mobile communications using a mobile phone or the like, the Internet, a local area network (LAN), and a virtual private network (VPN), regardless of wired or wireless.

The terminal apparatus 12 is a computer used for inputting and referring to the production plan by the manager who prepares and manages the production plan. For example, the terminal apparatus 12 is a desktop personal computer (PC), or a notebook PC. The manager uses the terminal apparatus 12 to transmit various operation instructions related to the production plan to the production plan preparation support apparatus 11, and form the production plan using the production plan preparation support apparatus 11. Although FIG. 1 illustrates the example in the case where one terminal apparatus 12 is used, the structure is not limited to it, and a desired number of terminal apparatuses 12 may be used.

The production plan preparation support apparatus 11 is an apparatus that executes various processes related to the production plan. For example, the production plan preparation support apparatus 11 is a computer such as a server computer. The production plan preparation support apparatus 11 may be mounted as a computer, or as a cloud formed of a plurality of computers. For example, the production plan preparation support apparatus 11 may be mounted as an application server that executes various processes related to the production plan, and a database server that stores therein various pieces of information related to the production plan. As another example, the production plan preparation support apparatus 11 may be mounted as a stand-alone apparatus that is directly operated by the manager. The present embodiment illustrates an example where the production plan preparation support apparatus 11 is a computer. In the production plan preparation support apparatus 11, software that supports preparation of the production plan operates to execute processing in response to a request received from the terminal apparatus 12. The production plan preparation support apparatus 11 generates information of a processing result such as image information of an execution result of the processing, and transmits the information to the terminal apparatus 12 serving as the request source.

Configuration of Production Plan Preparation Support Apparatus

Next, the configuration of the production plan preparation support apparatus 11 according to the present embodiment will be explained. FIG. 2 is a diagram illustrating an example of a functional configuration of the production plan preparation support apparatus. As illustrated in FIG. 2, the production plan preparation support apparatus 11 includes a communication interface (I/F) unit 20, a storage unit 21, and a controller 22. The production plan preparation support apparatus 11 may also include various known functional units as well as the functional units illustrated in FIG. 2. For example, the production plan preparation support apparatus 11 may include an input unit to input various pieces of information, and a display unit to display various pieces of information.

The communication I/F unit 20 is an interface that performs control of communication with other devices. The communication I/F unit 20 transmits and receives various pieces of information to and from other devices via the network 13. For example, the communication I/F unit 20 receives various operation instructions related to the production plan from the terminal apparatus 12. In addition, the communication I/F unit 20 transmits image information of an execution result of the processing in response to the operation instruction to the terminal apparatus 12. A network interface card such as a LAN card may be adopted as the communication I/F unit 20.

The storage unit 21 is a storage device that stores therein various pieces of data. For example, the storage unit 21 is a storage device such as a hard disk, a solid state drive (SSD), and an optical disk. The storage unit 21 may be a data rewritable semiconductor memory such as a random access memory (RAM), a flash memory, and a non-volatile static random access memory (NVSRAM).

The storage unit 21 stores therein an operating system (OS) and various computer programs executed by the controller 22. For example, the storage unit 21 stores therein various computer programs including a production plan preparation support program that executes a movement destination distinction display process, a task period display process, and a movement process described later. The storage unit 21 also stores therein various pieces of data used for the programs executed by the controller 22. For example, the storage unit 21 stores therein task information 30, production facility information 31, and switching task information 32.

The task information 30 is data obtained by storing information related to various tasks executed in the production plan. For example, the task information 30 includes information such as the produced commodity item, the facility that executes the task, and the task period for each task to be executed.

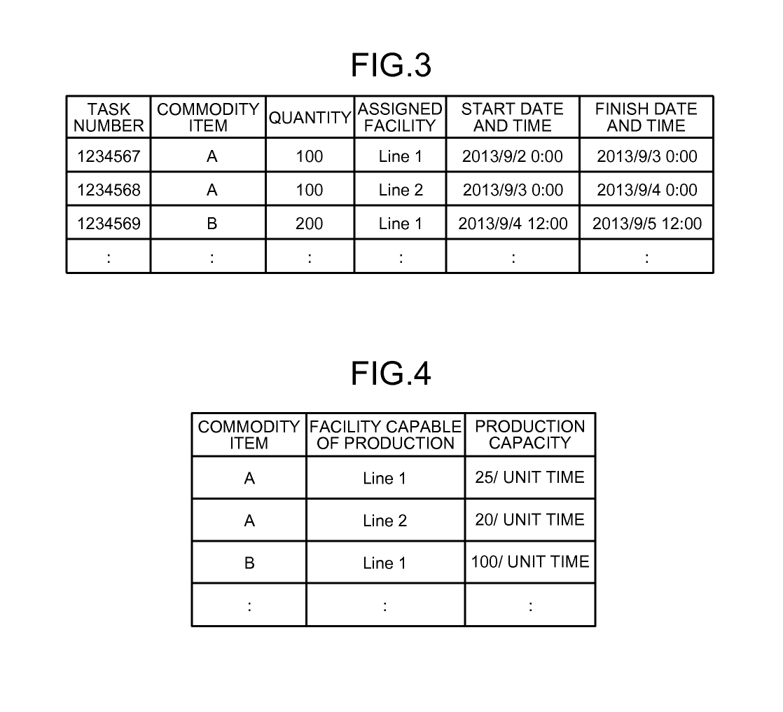

FIG. 3 is a diagram illustrating an example of a data configuration of the task information. As illustrated in FIG. 3, the task information 30 includes items “task number”, “commodity item”, “quantity”, “assigned facility”, “start date and time”, and “finish date and time”. The item of the task number is a region storing therein identification information for identifying the task. Each task is provided with a unique task number as identification information for identifying the task. The item of the task number stores therein a task number allocated to the task. The item of the commodity item is a region storing therein information that indicates the commodity item produced by the task. The item of the commodity item stores therein information such as a commodity item code indicating the commodity item. The item of the quantity is a region storing therein the quantity of the commodity item produced by the task. The item of the assigned facility is a region storing therein information that indicates the facility in which the task is executed. In the present embodiment, information related to the production line for producing the products is used as the information that indicates the facility. The start date and time is a region storing therein the date and time when the task is started. The finish date and time is a region storing therein the date and time when the task is finished. The task information 30 may include other setting items. For example, the task information 30 may include items such as the due date of production, the date when production can be started, an item for setting task that is to be finished before the task, and an item for setting task that is to be started after the task.

The example illustrated in FIG. 3 indicates that the task number “1234567” is task in which the commodity item “A” with a quantity “100” is produced in the assigned facility “Line 1”. The example also indicates that the task number “1234567” is started at the date and time “2013/9/2 0:00”, and finished at the date and time “2013/9/3 0:00”. The example also indicates that the task number “1234568” is task in which the commodity item “A” with a quantity “100” is produced in the assigned facility “Line 2”. The example also indicates that the task number “1234568” is started at the date and time “2013/9/3 0:00”, and finished at the date and time “2013/9/4 0:00”. The example also indicates that the task number “1234569” is task in which the commodity item “B” with a quantity “200” is produced in the assigned facility “Line 1”. The example also indicates that the task number “1234569” is started at the date and time “2013/9/4 12:00”, and finished at the date and time “2013/9/5 12:00”.

With reference to FIG. 2 again, the production facility information 31 is data obtained by storing information related to the facility that is capable of producing the commodity item. For example, the production facility information 31 includes information related to the facility that is capable of producing the commodity item and the production capacity thereof.

FIG. 4 is a diagram illustrating an example of a data configuration of the production facility information. As illustrated in FIG. 4, the production facility information 31 includes items “commodity item”, “facility capable of production”, and “production capacity”. The item of the commodity item is a region that stores therein identification information of the commodity item such as a commodity item code indicating the commodity item. The item of the facility capable of production is a region that stores therein information indicating the facility capable of producing the commodity item. In the present embodiment, information related to the production line that produces the products is used as the information indicating the facility. The item of the production capacity is a region that stores therein information indicating the production capacity in the case where the commodity item is produced in the facility. In the present embodiment, the number of products that can be produced per unit time is used as the information indicating the production capacity. The information indicating the production capacity may be the time for producing a product.

The example in FIG. 4 indicates that commodity item “A” with a quantity of 25 can be produced per unit time in the facility “Line 1”. The example also indicates that the commodity item “A” with a quantity of 20 can be produced per unit time in the facility “Line 2”. The example also indicates that the commodity item “B” with a quantity of 100 can be produced per unit time in the facility “Line 1”.

As illustrated in FIG. 4, the different production lines may have different production capacities for the same commodity item. For example, with respect to the facility “Line 1” and the facility “Line 2” in FIG. 4, the facility “Line 1” is capable of producing more quantity of the commodity item “A” per unit time than the facility “Line 2”. In addition, the production line may produce a plurality of types of products. For example, the facility “Line 1” is capable of producing the commodity item “A” and the commodity item “B”.

For example, when different types of products are produced in a single facility, setup change may be performed. Setup change is setup task performed for the facility to switch the products. For example, in a facility, there are cases where a second task is performed after a first task is performed. In such a case, there are cases of performing task to change the jig for producing the target product of the first task to the jig for producing the target product of the second task, as setup change. The setup change includes cleaning, preparation of the material, machine, jigs and tools, and drawings before starting the task, and test processing.

With reference to FIG. 2 again, the switching task information 32 is data obtained by storing information related to setup change. For example, the switching task information 32 includes commodity items that need setup change in switching commodity items to be produced, and information related to necessary setup change.

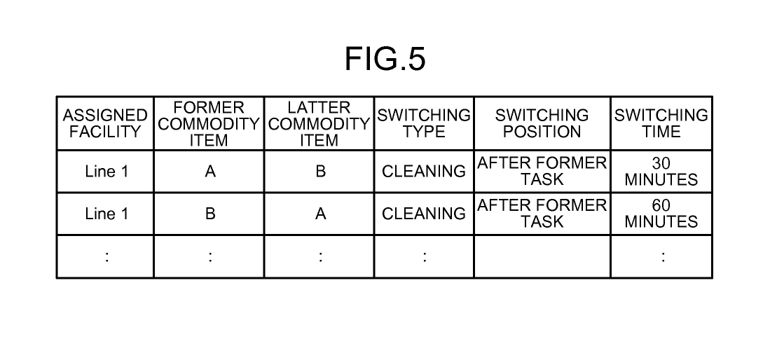

FIG. 5 is a diagram illustrating an example of a data configuration of the switching task information. As illustrated in FIG. 5, the switching task information 32 includes items “assigned facility”, “former commodity item”, “latter commodity item”, “switching type”, “switching position”, and “switching time”. The item of the assigned facility is a region that stores therein information indicating the production line that produces the products. The item of the former commodity item is a region that stores therein the commodity item produced before setup change in switching the produced commodity items in the production line. The item of the latter commodity item is a region that stores therein the commodity item to be produced after setup change in switching the produced commodity items in the production line. The item of the switching type is a region that stores therein the type of the setup change. The type of the setup change indicates, for example, task executed as the setup change, such as various preparatory tasks such as cleaning and jig change. The item of the switching position is a region that stores therein information indicating the timing for performing the setup change task. In the present embodiment, the timing for performing the setup change task can be set to the case of performing the setup change task directly after the former task is finished, and the case of performing the setup change task directly before the latter task is started. In the case where the setup change task is performed directly after the former task is finished, the setting “after the former task” is provided in the item of the switching position. In the case where the setup change task is performed directly before the latter task is started, the setting “before the latter task” is provided in the item of the switching position. The item of the switching time is a region that stores therein the task time for the setup change task.

The example in FIG. 5 indicates that, when the produced commodity item is switched from “A” to “B” in the facility “Line 1”, cleaning task occurs directly after the task for the commodity item “A” is finished, and the task time is 30 minutes. The example also indicates that, when the produced commodity item is switched from “B” to “A” in the facility “Line 1”, cleaning task occurs directly after the task for the commodity item “B” is finished, and the task time is 60 minutes.

With reference to FIG. 2 again, the controller 22 is a device that controls the production plan preparation support apparatus 11. As the controller 22, it is possible to adopt an electronic circuit such as a central processing unit (CPU) and a micro processing unit (MPU), or an integrated circuit such as an application specific integrated circuit (ASIC) and a field programmable gate array (FPGA). The controller 22 includes an internal memory to store therein programs prescribing various processing procedures and control data, to perform various processes with them. The controller 22 functions as various processors by operation of the various computer programs. The controller 22 displays various images on the terminal apparatus 12. The controller 22 also detects various operations on receipt of various operation instructions transmitted from the terminal apparatus 12 and related to the production plan. The controller 22 also performs control to update the various images displayed on the terminal apparatus 12 and related to the production plan, in response to the detected operations. For example, the controller 22 includes a first display controller 40, a detector 41, and a second display controller 42, as the processors related to the present embodiment.

The first display controller 40 performs display control of the various images. For example, the first display controller 40 performs display control to display a production plan image in which the production plan is displayed. When any operation to display a new window is detected in the production plan image, the first display controller 40 performs display control to display a new window area.

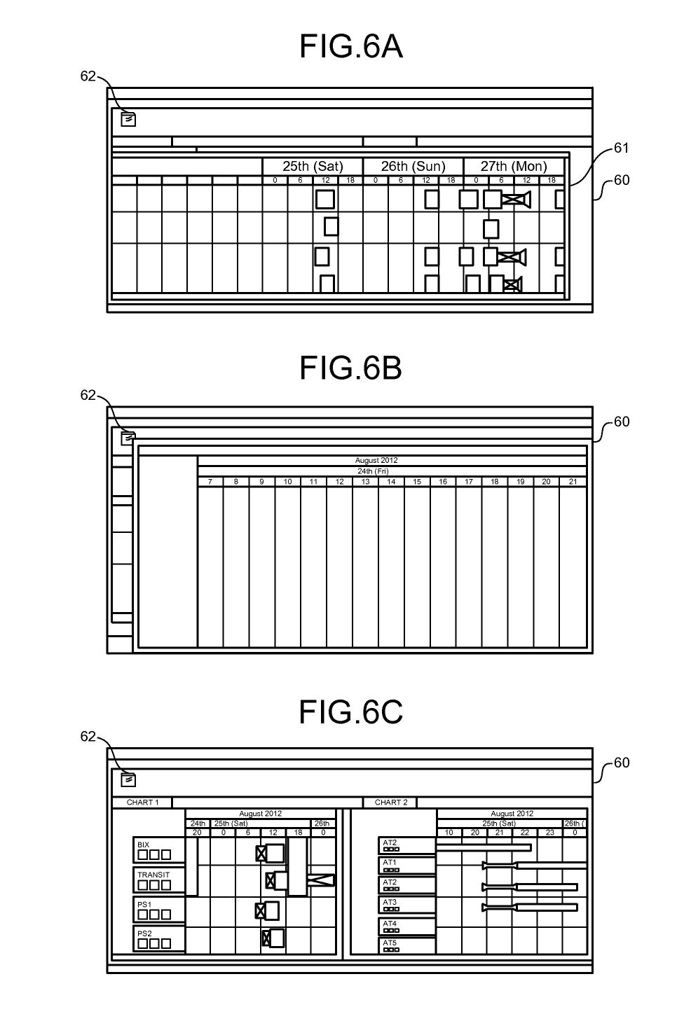

Explanation will be made with a specific example. FIG. 6A to FIG. 6C are diagrams illustrating an example of the production plan image in which the production plan is displayed.

The production plan image 60 illustrated in FIG. 6A is provided with a display area 61 illustrating a Gantt chart in which task objects that indicate respective planned tasks are arranged for each production line. The display area 61 serves as a window area, and can be individually separated from the production plan image 60. The production plan image 60 is also provided with command buttons for performing various operations in the upper part of the image. In the example illustrated in FIG. 6A to FIG. 6C, only a command button related to the present embodiment is illustrated in the upper part of the image, that is, a multi-chart button 62 is provided. The multi-chart button 62 is a button for commanding opening another window area for displaying the production plan image 60.

The manager can display different parts of the production plan on a plurality of windows by selecting the multi-chart button 62.

When the multi-chart button 62 of the production plan image 60 is selected, the first display controller 40 displays a new window. FIG. 6B illustrates a state where a new window is displayed. The displayed window area may be coupled with the production plan image 60. FIG. 6C illustrates a state where the new window is coupled with the production plan image 60 to display the two window areas side by side.

The following describes the effect obtained by enabling the production plan image 60 to be displayed in a plurality of windows. First, a description is made for the case of displaying the production plan image 60 divided into a plurality of regions, for the sake of comparison.

When the entire production plan image 60 with a large production scale is contained and displayed in a display area, the production plan image 60 is displayed in a reduced and small size, making it difficult to check the production plan. For this reason, for example, it can be adopted to set a part of the production plan image as the display area, to change the display area by scroll.

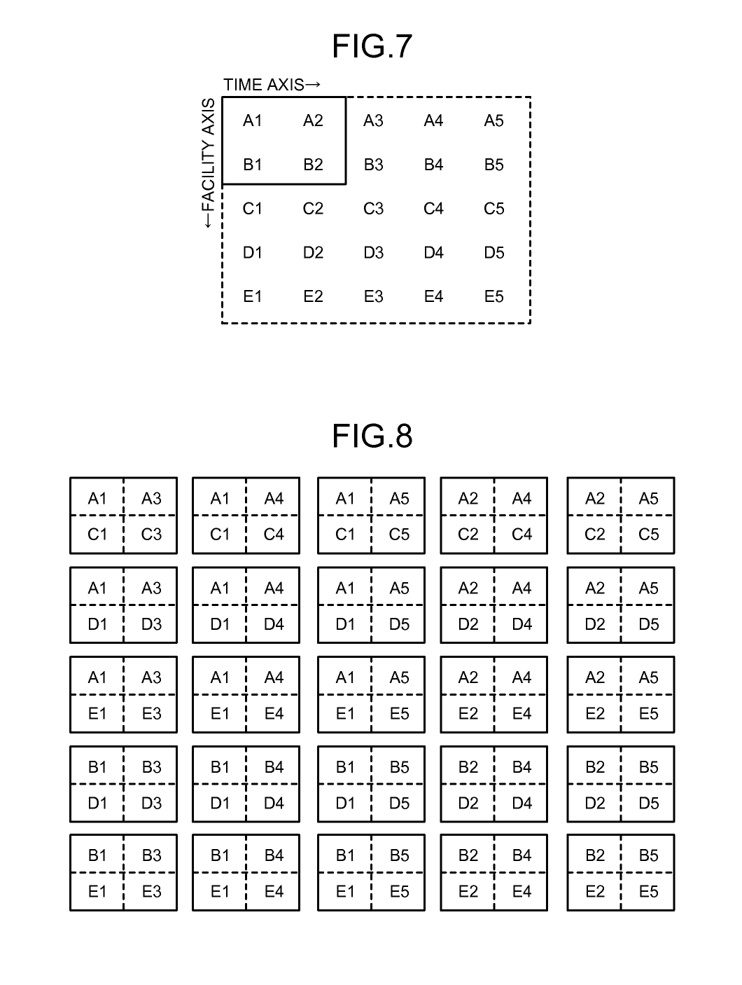

FIG. 7 is a schematic diagram of the image area of the production plan image. In the example illustrated in FIG. 7, the image area of the production plan image 60 has a structure in which parts A to E are arranged in a vertical direction serving as an axis along which facilities are arranged, and parts 1 to 5 are arranged in a horizontal direction serving as a time axis. In the following description, the position in the image area is indicated by a combination of the vertical direction A to E and the horizontal direction 1 to 5. Part of the image area is set as the display area of the production plan image. The example of FIG. 7 indicates a display area in a rectangular shape having a 2×2 size in the case of using the vertical directions A and B and the horizontal directions 1 and 2.

Suppose that the production plan image 60 can be displayed with the display area divided into a plurality of areas. For example, suppose that the production plan image 60 can be displayed with four divided areas obtained by dividing the display area into two in the vertical direction and two in the horizontal direction. In this case, the patterns of the displayed parts of the production plan image 60 are 25 patterns. FIG. 8 is a diagram illustrating patterns of the displayed parts. For example, the upper left pattern in FIG. 8 indicates the case of displaying the vertical directions A and C and the horizontal directions 1 and 3, in which four parts “A1”, “A3”, “C1”, and “C3” are displayed in the four divided areas.

In the case where the display area is divided into a plurality of areas to individually display the divided areas, the production plan image 60 has divided areas for which displayed parts are not individually adjusted. For example, with respect to the part “C3” in the upper left pattern in FIG. 8, the vertical position of the part “C3” is determined by “C” being the same as “C1”, and the horizontal position of the part “C3” is determined by “3” being the same as “A3”. Specifically, the displayed part for the part “C3” is determined by the vertical position of “C1” and the horizontal position of “A3”, and cannot be individually adjusted. For this reason, for example, when the manager selects the vertical positions “A” and “C” and the horizontal positions “1” and “3” to check the parts “A1”, “A3”, and “C1”, the part “C3” is also displayed together.

As described above, when the production plan image 60 is divided into a plurality of areas, there are cases where the production plan image 60 includes divided areas for which the displayed parts are not individually adjusted. When the scale of production is large, the production plan image 60 has an image area with a large size. For this reason, when the production plan image 60 includes any divided areas that are not adjusted, the display area is not effectively used, because at least one of the divided areas may serve as useless display.

By contrast, the production plan image 60 illustrated in FIG. 6B and FIG. 6C may be displayed with a plurality of windows, and display areas of the respective window areas can be individually changed. With this structure, for example, even when four window areas are arranged in the production plan image 60, the display areas of the four respective window areas can be changed. This structure enables effective use of the display area, and efficient check of the production plan.

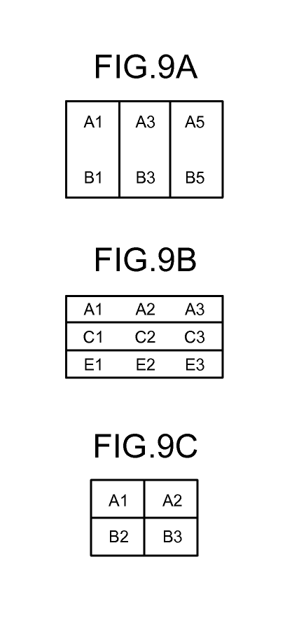

The production plan image 60 can be displayed as follows, by arranging a plurality of window areas. FIG. 9A to FIG. 9C are diagrams illustrating an example of arrangement of window areas. In the example in FIG. 9A, three window areas that are vertically long are arranged to display “A1” and “B1”, “A3” and “B3”, “A5” and “B5” in FIG. 7 in the respective window areas. When three vertically long window areas are arranged in the production plan image 60 as illustrated in FIG. 9A, the production plan image 60 enables easy comparison of the production plan between the different periods of time. In the example in FIG. 9B, three window areas that are horizontally long are arranged to display “A1”, “A2” and “A3”, “C1”, “C2” and “C3”, “E1”, “E2” and “E3” in FIG. 7 in the respective window areas. When three horizontally long window areas are arranged in the production plan image 60 as illustrated in FIG. 9B, the production plan image 60 enables easy comparison of the production plan between the different production lines. In the example in FIG. 9C, four window areas are arranged in two columns and two rows to display “A1”, “A2”, “B2”, and “B3” in FIG. 7. When four window areas are arranged in the production plan image 60 as illustrated in FIG. 9C, the production plan image 60 enables easy consideration of the production plan with reference to the production plan of another production line in the different period of time. For example, the production plan for the commodity item X is displayed in “B2” and “B3”, and the production plan for the commodity item Y serving as a component of the commodity item X and produced before the commodity item X is displayed in “A1” and “A2”. This display enables the manager to consider the production plan for the commodity item X while checking the production plan for the commodity item Y.

The production plan image 60 enables edit of each task object displayed in each window area. For example, the production plan image 60 enables movement of the task object by drag and drop of the task object between the window areas. For example, the manager moves the task object between the window areas of the production plan image 60 by drag and drop.

The detector 41 performs various detections. For example, the detector 41 detects various operation instructions related to the production plan. For example, the detector 41 detects an operation for displaying a new window for the production plan image 60. In addition, when any task object is dragged in any window area of the production plan image 60, the detector 41 detects selection of the task object on the Gantt chart displayed in the window area. The detector 41 also detects the position of the task object being dragged. In addition, when the dragged task object is dropped onto any window area of the production plan image 60, the detector 41 detects the dropping position of the task object in the window area.

The second display controller 42 performs control to update various images displayed on the terminal apparatus 12 and related to the production plan, in accordance with the operations detected by the detector 41. For example, when the detector 41 detects selection of any task object on the Gantt chart displayed in the window area, the second display controller 42 distinguishably displays a movement destination to which the selected task object can be moved. For example, the second display controller 42 refers to the production facility information 31, to read out the item of the facility capable of production with the item of the commodity item in which the commodity item of the selected task object is registered, and specify the facility that is capable of producing the commodity item of the selected task object. Next, the second display controller 42 distinguishably displays the facility that is capable of producing the commodity item of the selected task object, in the production plan image 60. For example, the second display controller 42 grays facilities other than the facility capable of producing the commodity item of the selected task object in the production plan image 60, to distinguishably display the facility capable of producing the commodity item.

In addition, during drag, the second display controller 42 distinguishably displays the task period of the task object in the case where the task object being dragged is disposed in the dragging position. First, the second display controller 42 specifies whether the commodity item of the selected task object can be produced by the facility in the position where the selected task object is being dragged. For example, the second display controller 42 specifies whether the commodity item of the selected task object can be produced, based on whether the commodity item of the selected task object is registered in the item of the commodity item for the facility in the position where the selected task object is being dragged, with reference to the production facility information 31. When the commodity item can be produced by the facility, the second display controller 42 specifies the production capacity in the case where the commodity item of the selected task object is produced by the facility in the position where the selected task object is being dragged, with reference to the production facility information 31. Next, the second display controller 42 determines the period for producing the quantity of the commodity item of the task object being dragged, based on the specified production capacity. For example, the second display controller 42 determines the finish date and time of the period for producing the quantity of the commodity item of the task object being dragged, with the position where the task object is being dragged set as the start date and time. Next, the second display controller 42 distinguishably displays the region having a length corresponding to the determined period. For example, the second display controller 42 distinguishably displays the region having a length corresponding to the determined period.

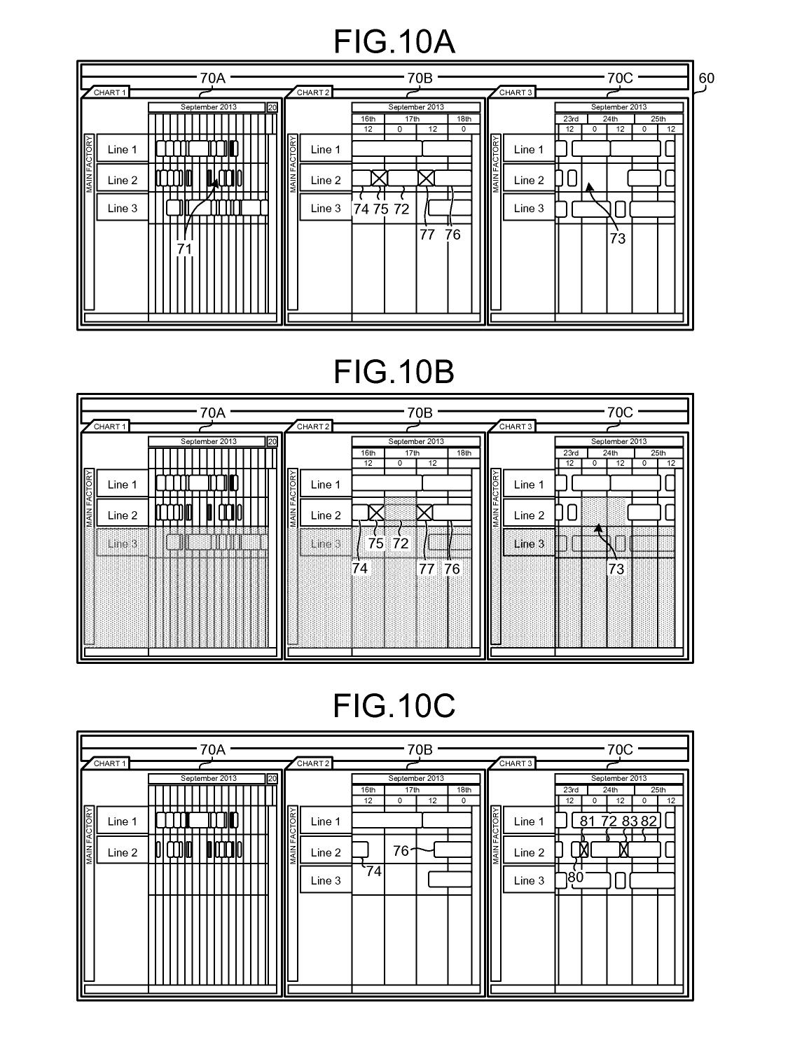

The following is a description with reference to a specific example. FIG. 10A to FIG. 10C are diagrams illustrating an example of the production plan image in which the production plan is displayed. In the production plan image 60 illustrated in FIG. 10A to FIG. 10C, three window areas 70A to 70C that are vertically long are displayed side by side. The production plan for the facilities Line 1 to Line 3 in September 2013 is displayed in the window area 70A. The production plan for the facilities Line 1 to Line 3 from Sep. 16, 2013 to Sep. 18, 2013 is displayed in an enlarged state in the window area 70B. The production plan for the facilities Line 1 to Line 3 from Sep. 23, 2013 to Sep. 25, 2013 is displayed in an enlarged state in the window area 70C.

The manager recognizes that the region 71 of the facility Line 1 has a vacant period, with reference to the window area 70A, and supposes the case of moving the task object 72 in the facility Line 2 of the window area 70B to a region 73 in the window area 70C corresponding to the region 71. In the example in FIG. 10A, a setup task 75 exists between the task object 72 and the previous task object 74, and a setup task 77 exists between the task object 72 and the following task object 76.

The manager drags and selects the task object 72 in the window area 70B, to move the task object 72 to the region 73. The second display controller 42 distinguishably displays the facilities capable of producing the commodity item to be produced in the selected task object 72. FIG. 10B illustrates a state where the task object 72 of the window area 70B is selected. Suppose that the task object 72 can be produced by the facilities Line 1 and Line 2. In the window area 70A, the facility Line 3 that is not capable of producing the commodity item to be produced in the task object 72 is displayed in gray color. In this manner, the manager can recognize the facilities to which the selected task object 72 can be moved. The second display controller 42 also distinguishably displays the region of the task period of the task object 72 in gray in the case where the task object 72 is disposed in the position where the task object is being dragged, during drag. FIG. 10B illustrates the state where the task object 72 is moved to the region 73 while being dragged. In the region 73, the task period in the case where the task object 72 is disposed in the region 73 is grayed to be distinguishably displayed. When a non-operating period in which the facility is not operated and performs no production is set for each facility, the second display controller 42 may distinguishably display the task period in gray except for the non-operating period. For example, when a non-operating period is set in which the factory is stopped such as night, the second display controller 42 may determine the task period excluding the non-operating period, to distinguishably display the task period.

When the detector 41 detects an operation of disposing the task object in the window area, the second display controller 42 moves the selected task object to the disposed position. For example, the second display controller 42 specifies the production capacity in the case where the commodity item of the disposed task object is produced by the facility in the disposed position, with reference to the production facility information 31. Next, the second display controller 42 determines the period for producing the quantity of the commodity item of the disposed task object with the specified production capacity. For example, the second display controller 42 determines the finish date and time of the period for producing the quantity of the commodity item of the disposed task object, with the disposed position used as the start date and time. Thereafter, the second display controller 42 disposes the task object with a length corresponding to the determined period. In addition, the second display controller 42 updates the task information 30 related to the disposed task object in accordance with the disposed position.

In addition, the second display controller 42 determines whether any setup change is registered between the disposed task object and the previous task object, and between the disposed task object and the following task object, in the facility serving as the movement destination, with reference to the switching task information 32. When any setup change is registered, the second display controller 42 disposes an object of the registered setup change with a length corresponding to the switching time. In this operation, when the switching position is “after the former task”, the second display controller 42 disposes the setup change task object directly after finish of the previous task. By contrast, when the switching position is “before the latter task”, the second display controller 42 disposes the setup change task object directly before start of the following task.

The second display controller 42 also determines whether any setup change is registered between the task object previous to the task object moved to another facility and the following task object, in the facility serving as the movement source, with reference to the switching task information 32. When any setup change is registered, the second display controller 42 disposes an object of the registered setup change with a length corresponding to the switching time. In this operation, when the switching position is “after the former task”, the second display controller 42 disposes the setup change task object directly after finish of the previous task. By contrast, when the switching position is “before the latter task”, the second display controller 42 disposes the setup change task object directly before start of the following task.

FIG. 10C illustrates the state where the task object 72 of the window area 70B has been moved to the region 73 of the window area 70C. In the window area 70B, the setup task 75 and the setup task 77 are canceled because the task object 72 has been moved. Suppose that no setup task is required between the task object 74 and the task object 76. In the window area 70C, because the task object 72 has been moved into the window area 70C, a setup task 81 is added between the task object 72 and the previous task object 80, and a setup task 83 is added between the task object 72 and the following task object 82.

With this structure, when the manager moves a task object, because the manager can perform operation while checking the states of the facilities before the movement and after the movement with a single display, the manager can easily edit the production plan.

Flow of Process

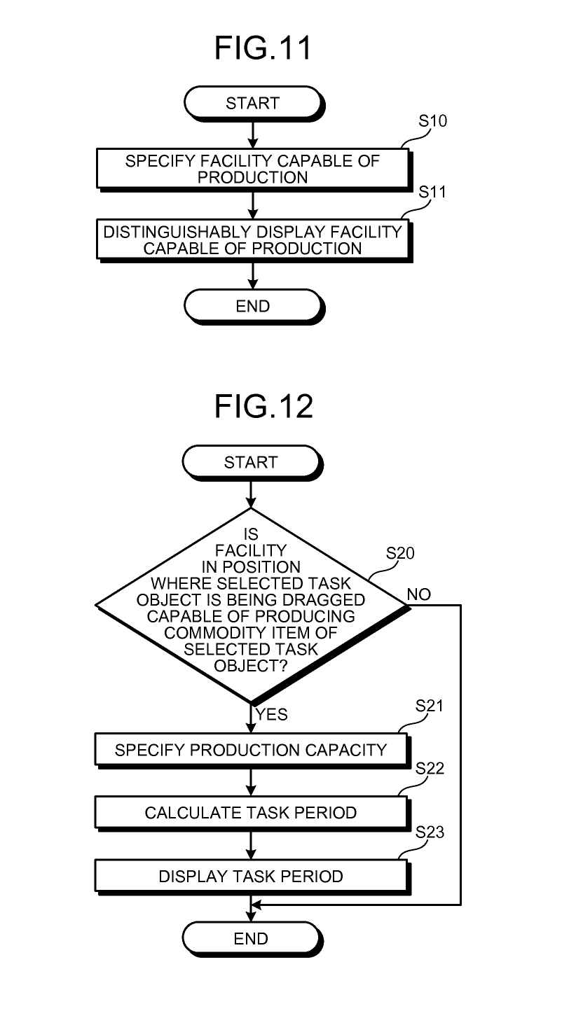

The following describes flows of various processes performed by the production plan preparation support apparatus 11 according to the present embodiment. First, a description is made for the flow of a movement destination distinction display process performed by the production plan preparation support apparatus 11 according to the present embodiment to distinguishably display the movement destination to which the selected task object can be moved. FIG. 11 is a flowchart illustrating an example of procedures of the movement destination distinction display process. The movement destination distinction display process is performed at predetermined timing, for example, at timing at which a task object on the Gantt chart displayed in the window area is selected.

As illustrated in FIG. 11, the second display controller 42 refers to the production facility information 31, to read out the item of the facility capable of production with the item of the commodity item in which the commodity item of the selected task object is registered, and specify the facility that is capable of producing the commodity item of the selected task object (step S10). The second display controller 42 grays facilities other than the facility capable of producing the commodity item of the selected task object in the production plan image 60, to distinguishably display the facility capable of producing the commodity item (step S11), and end the process.

Next, a description is made for the flow of the task period display process performed by the production plan preparation support apparatus 11 according to the present embodiment to distinguishably display the task period of the task object in the case where the selected task object is disposed. FIG. 12 is a flowchart illustrating an example of procedures of the task period display process. The task period display process is properly performed at predetermined timing, for example, at timing at which the selected task object being dragged has been moved onto another facility.

As illustrated in FIG. 12, the second display controller 42 specifies whether the commodity item of the selected task object can be produced by the facility in the position where the selected task object is being dragged (step S20). For example, the second display controller 42 refers to the production facility information 31, to determine whether the commodity item can be produced, based on whether the commodity item of the selected task object is registered in the item of the commodity item for the facility in the position where the selected task object is being dragged. If the commodity item cannot be produced by the facility (No at step S20), the process is ended.

By contrast, if the commodity item can be produced by the facility (Yes at step S20), the second display controller 42 specifies the production capacity in the case where the commodity item of the selected task object is produced by the facility in the position where the selected task object is being dragged, with reference to the production facility information 31 (step S21). The second display controller 42 determines the task period for producing the quantity of commodity item of the task object being dragged, based on the specified production capacity (step S22). The second display controller 42 distinguishably displays the region having a length corresponding to the determined task period (step S23), and ends the process.

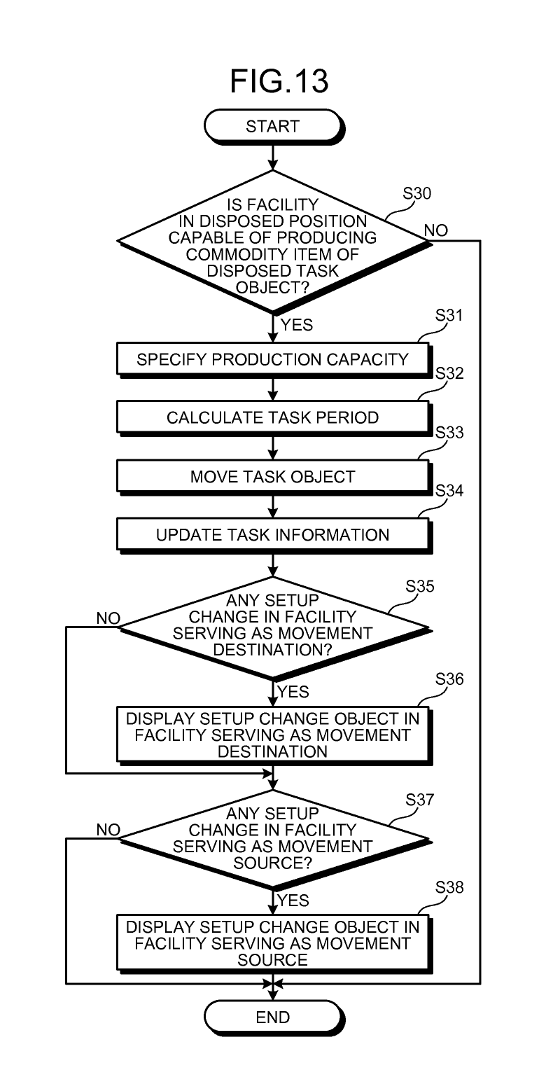

Next, a description is made for the flow of the movement process performed by the production plan preparation support apparatus 11 according to the present embodiment to move the selected task object. FIG. 13 is a flowchart illustrating an example of procedures of the movement process. The movement process is performed at predetermined timing, for example, at timing at which the selected task object is disposed.

As illustrated in FIG. 13, the second display controller 42 specifies whether the commodity item of the disposed task object can be produced by the facility in the disposed position (step S30). For example, the second display controller 42 determines whether the commodity item can be produced, based on whether the commodity item of the disposed task object is registered in the item of the commodity item for the facility in the disposed position, with reference to the production facility information 31. If the commodity item cannot be produced by the facility (No at step S30), the process is ended.

By contrast, if the commodity item can be produced by the facility (Yes at step S30), the second display controller 42 specifies the production capacity in the case where the commodity item of the disposed task object is produced in the facility of the disposed position, with reference to the production facility information 31 (step S31). The second display controller 42 determines the task period for producing the quantity of the commodity item of the disposed task object, based on the specified production capacity (step S32). The second display controller 42 disposes the task object with a length corresponding to the determined task period, and performs control to delete the task object from the movement source and move the task object (step S33). The second display controller 42 also updates the task information 30 related to the disposed task object in accordance with the disposed position (step S34).

The second display controller 42 refers to the switching task information 32, to determine whether any setup change is registered between the disposed task object and the previous task object, and between the disposed task object and the following task object, in the facility serving as the movement destination (step S35). If no setup change is registered (No at step S35), the process goes to step S37 described later. If any setup change is registered (Yes at step S35), the second display controller 42 disposes an object of the registered setup change with a length corresponding to the switching time, in the facility serving as the movement destination (step S36).

The second display controller 42 also determines whether any setup change is registered between the task object previous to the task object moved to another facility and the following task object, in the facility serving as the movement source, with reference to the switching task information 32 (step S37). If no setup change is registered (No at step S37), the process is ended. By contrast, if any setup change is registered (Yes at step S37), the second display controller 42 disposes an object of the registered setup change with a length corresponding to the switching time, in the facility serving as the movement source (step S38), and ends the process.

Effects

As described above, the production plan preparation support apparatus 11 according to the present embodiment displays a Gantt chart including a plurality of task objects in a first window area and a second window area. The production plan preparation support apparatus 11 detects an operation of selecting a task object on the Gantt chart displayed in the first window area and disposing the task object on the Gantt chart displayed in the second window area. When the production plan preparation support apparatus 11 detects the above operation, the production plan preparation support apparatus 11 displays a result obtained by moving the task object on the Gantt charts displayed in the first window area and the second window area, in a position where the task object is disposed on the Gantt chart displayed in the second window area. In this manner, the production plan preparation support apparatus 11 enables easy edit of the production plan.

In addition, when a limit to the movement destination is set for the selected task object, the production plan preparation support apparatus 11 according to the present embodiment distinguishably displays the movement destination to which the task object can be moved in the first window area and the second window area. In this manner, the production plan preparation support apparatus 11 enables the manager to recognize the movement destination to which the selected task object can be moved.

### [b] Second Embodiment

Although the embodiment related to the disclosed apparatus has been described above, the disclosed technique may be carried out in various different forms other than the embodiment described above.

In addition, it is noted that the components of each illustrated apparatus are functional concepts and are not always physically configured as illustrated in the drawings. That is, specific manners of distribution and integration of the apparatuses are not limited to those illustrated in the drawings and the whole or part thereof may be distributed or integrated functionally or physically in any units depending on various loads and use conditions. For example, the processors of the first display controller 40, the detector 41, and the second display controller 42 may be properly integrated. In addition, the process performed by each processor may properly be separated into processes performed by a plurality of processors. The whole or any part of the processing functions in each processor may be implemented by a CPU and a computer program that is analyzed and executed by the CPU, or may be implemented by hardware with wired logic.

Production Plan Preparation Support Program

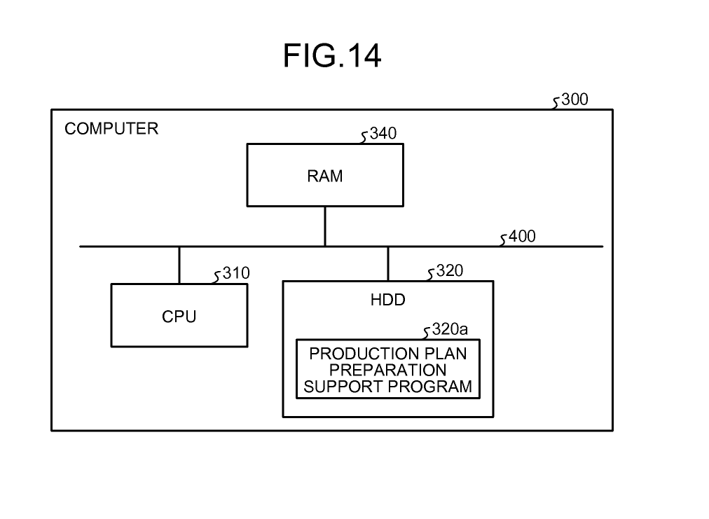

The processes described in the above embodiment can be implemented by executing a computer program prepared in advance by a computer system such as a personal computer and a workstation. The following is an example of a computer system that executes a computer program having the same function as that of the above embodiment. FIG. 14 is a diagram illustrating a computer that executes a production plan preparation support program.

As illustrated in FIG. 14, a computer 300 includes a central processing unit (CPU) 310, a hard disk drive (HDD) 320, and a random access memory (RAM) 340. These units 300 to 340 are connected via a bus 400.

The HDD 320 stores therein in advance a production plan preparation support program 320a that performs the same functions as those of the first display controller 40, the detector 41, and the second display controller 42 described above. The production plan preparation support program 320a may be properly separated.

The HDD 320 stores therein various pieces of information. For example, the HDD 320 stores therein an OS and various pieces of data used for estimating the direction of movement to the terminal to be tracked.

The CPU 310 reads out and executes the production plan preparation support program 320a from the HDD 320, whereby the same operations as those of the processors of the embodiment are performed. Specifically, the production plan preparation support program 320a performs the same operations as those of the first display controller 40, the detector 41, and the second display controller 42.

The above production plan preparation support program 320a is not always required to be stored in the HDD 320 in advance.

For example, the program may be stored in a “portable physical medium” such as a flexible disk (FD), a compact disc read only memory (CD-ROM), a digital versatile disc (DVD), a magnetooptical disc (MO), and an integrated circuit (IC) card to be inserted into the computer 300. The computer 300 may read out and execute the program therefrom.

In addition, the program may be stored in “another computer (or server)” connected to the computer 300 via a public line, the Internet, a LAN, or a wide area network (WAN), and the computer 300 may read out and execute the program therefrom.

An aspect of the invention enables easy edit of the production plan.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a production plan preparation support program causing a computer to execute a process comprising:
displaying a Gantt chart including a plurality of task objects in a first window area and a second window area; and
displaying, when detecting an operation of selecting a task object on the Gantt chart displayed in the first window area and disposing the task object on the Gantt chart displayed in the second window area, a result of moving the task object on the Gantt chart displayed in the first window area and the second window area, in a position where the task object is disposed on the Gantt chart displayed in the second window area.

2. The non-transitory computer-readable recording medium according to claim 1, wherein the process further comprises:
distinguishably displaying a movement destination to which the selected task object is allowed to be moved in the first window area and the second window area, when a limit to the movement destination is set for the selected task object.

3. A production plan preparation support method comprising:
displaying a Gantt chart including a plurality of task objects in a first window area and a second window area, using a processor; and
displaying, when detecting an operation of selecting a task object on the Gantt chart displayed in the first window area and disposing the task object on the Gantt chart displayed in the second window area, a result of moving the task object on the Gantt chart displayed in the first window area and the second window area, in a position where the task object is disposed on the Gantt chart displayed in the second window area, using the processor.

4. A production plan preparation support apparatus comprising a processor that executes a process including:
displaying a Gantt chart including a plurality of task objects in a first window area and a second window area;
detecting an operation of selecting a task object on the Gantt chart displayed in the first window area and disposing the selected task object on the Gantt chart displayed in the second window area; and
displaying a result of moving the task object on the Gantt chart displayed in the first window area and the second window area, in a position where the operation of disposing is detected at the detecting.
